(19) United States
(12) Patent Application Publication
(10) Pub. No.: US 2013/0046636 A1
(43) Pub. Date: Feb. 21, 2013

(54) Location-Aware Mobile Advertising

(71) Applicant: Benyam Tesfaye Asnake, Marietta, GA (US)

(72) Inventor: Benyam Tesfaye Asnake, Marietta, GA (US)

(21) Appl. No.: 13/589,918

(22) Filed: Aug. 20, 2012

Related U.S. Application Data
(60) Provisional application No. 61/524,834, filed on Aug. 18, 2011.

(51) Int. Cl. G06Q 30/02

(52) U.S. Cl. 705/14.63

(57) ABSTRACT

Systems and methods are described herein for location-aware mobile advertising. Systems and methods associated with mobile advertising may support location-aware mobile advertising delivery of advertising content to mobile platforms based upon geographical location. For example, a display system on or in a taxi cab, bus, or other mobile platform can display advertising video, audio, images, messages, or any combination thereof. The advertising content being displayed at a given time may be selected based on a function of the location, direction, or speed of the mobile platform. The function may also involve the time, date, or many other factors and parameters.

### RELATED APPLICATION

This application claims priority to U.S. Provisional Patent Application No. 61/524,834, filed Aug. 18, 2011 and entitled “Location-Aware Mobile Advertising.” The complete disclosure of the above-identified priority application is hereby fully incorporated herein by reference.

### BACKGROUND

Advertising in public spaces, such as the side of a bus, provides a high visibility marketing opportunity. There is a need in the art to fully leverage such public display advertising by enabling a dynamically changing display system and a marketplace for advertisers to select and purchase important criteria for when and where their advertisement may be displayed according to their specific advertising campaigns or marketing strategies.

### SUMMARY

Technologies are described herein for location-aware mobile advertising. Systems and methods associated with mobile advertising may support location-aware mobile advertising delivery of advertising content to mobile platforms based upon geographical location. For example, a display system on or in a taxi cab, bus, or other mobile platform can display advertising video, audio, images, messages, or any combination thereof. The advertising content being displayed at a given time may be selected based on a function of the location, direction, or speed of the mobile platform. The function may also involve the time, date, or many other factors and parameters.

It should be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 depicts a block diagram illustrating a location-aware mobile advertising system according to one or more embodiments of the technology presented herein.

FIG. 2 depicts a flow diagram illustrating aspects of a process for advertising server functionality associated with a location-aware mobile advertising system according to one or more embodiments presented herein.

FIG. 3 depicts a flow diagram illustrating aspects of a process for mobile system functionality associated with a location-aware mobile advertising system according to one or more embodiments presented herein.

FIG. 4 depicts a flow diagram illustrating aspects of a process for content scoring and fitness metric determination associated with a location-aware mobile advertising system according to one or more embodiments presented herein.

FIG. 5 depicts a block diagram illustrating a computer architecture configured to execute software components according to one or more embodiments presented herein.

### DETAILED DESCRIPTION

The following description is directed to technologies for location-aware mobile advertising. While portions of the subject matter described herein may be presented in the general context of program modules that execute in conjunction with the execution of an operating system and application programs on a computer system or embedded processor system, those skilled in the art will recognize that other implementations may be performed in combination with other types of program modules.

Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, smartphones, tablet computers, vehicular electronic systems, avionics, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for location-aware mobile advertising.

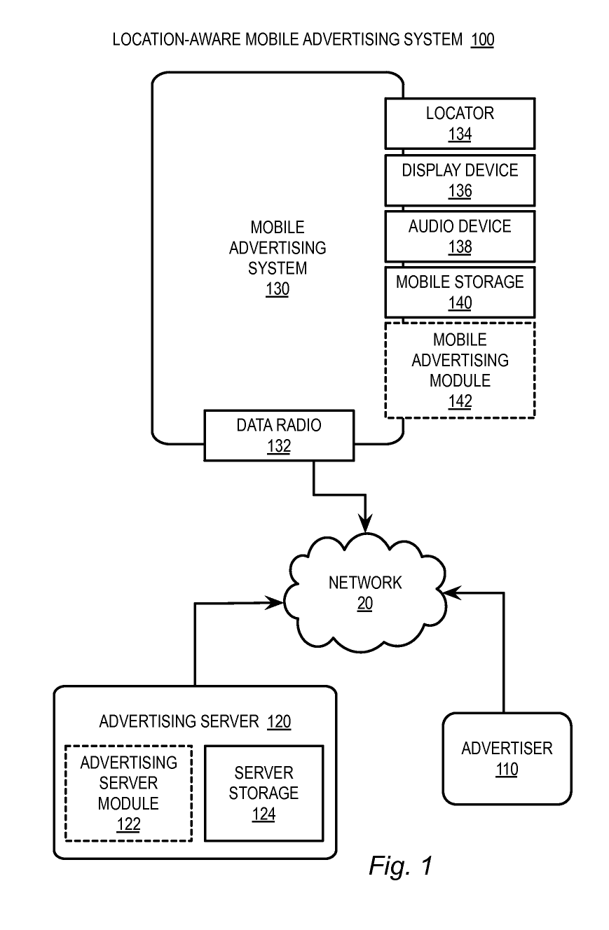

Turning now to FIG. 1, a block diagram illustrates a location-aware mobile advertising system 100 according to one or more embodiments of the technology presented herein. The location-aware mobile advertising system 100 can support an advertiser 110 buying advertising services online over a network 20. The purchase of advertising services may include uploading advertising content to an advertising server 120.

The advertising server 120 may execute computer readable instruction modules for performing functionality discussed herein. These modules may be collectively referred to as advertising server modules 122. The advertising server 120 may also store programs, data, and advertising content on server storage 124.

A mobile advertising system 130 may communicate with the advertising server 120 over the network 20 using a data radio 132 associated with the mobile advertising system 130. It should be appreciated that the network 20 connecting the advertiser 110 with the advertising server 120 may be the same, similar, entirely different, or partially different from the network 20 connecting the advertising server 120 to the mobile advertising system 130. The network 20 may be the Internet, a local network, metro network, wide-area network, mobile communications network, wireless, wired, optical, electrical, radio, packet-based, connection-based, telephone line, other network, or any combination thereof.

A locator 134 may be associated with the mobile advertising system 130 to support determining location and other characteristics of the mobile advertising system 130. The locator may be a global positioning system (GPS), a global navigation satellite system (GNSS), a local positioning system, a mobile communication assisted positioning system, LORAN, or any other positioning or location system.

A display device 136 and audio device 138 may be associated with the mobile advertising system 130 for displaying advertising content. It should be appreciated that references herein to displaying content includes playing, projecting, decoding, broadcasting, presenting, or otherwise making the content available to be seen and/or heard by one or more individuals. The mobile advertising system 130 and display device 136 may include indoor or outdoor display systems. The display device 136 may be mounted on a people mover such as a taxi cab, bus, truck, blimp, balloon, train, or so forth.

Mobile storage 140 at the mobile advertising system 130 may be used for storing data, or programs. This may include any advertising content to be displayed. This may also include machine executable software code referred to collectively as mobile advertising modules 142.

The advertising server 120 and associated advertising server modules 122 can support scoring and fitness metric functions and algorithms to determine at what time and at what mobile location advertising content may be displayed.

The advertising server 120 and associated advertising server modules 122 may support interfaces for access by web browsers, computer applications, user application, mobile applications, or any other access interface for users or machines.

The advertising server 120 can allow advertisers 110 to register, login, make payment and upload their advertisement media content. Related functions may include registering advertiser 110 (user name, password, contact info, name, email, address). After registering an advertiser 110 the system may notify a system administrator to review the registration.

The mobile advertising system 130 may also support advertiser 110 to add funds. The advertiser 110 may use an online merchant solution and/or direct credit card payment to fund their account used to pay for advertising.

The mobile advertising system 130 may also support advertiser 110 to upload media content by: prompting for media type (image, video, audio, etc.), prompting file location/path, prompting advertisement parameters (e.g. total number of minutes/hours to display advertisement, desired times, locations, demographics, etc.). This may be validated against available funds balance in advertiser's account. The desired location for advertising may be given by address, zip code, longitude/latitude, or any other geographic locator. A range may be specified such as a radius or number of surrounding zip codes, neighborhoods, or any other geographic demarcation unit. Dates and times may also be specified for when to display, or not display, advertisement content.

Advertising fees may be a function of the specificity of advertising parameters such as time of day, location, and so forth. For example, an advertisement targeting rush-hour traffic may incur a higher fee than an advertisement that can be displayed at any time of day. Similarly, advertisers may submit advertisement content with few constraints for reduced fees.

The mobile advertising system 130 can validate the address and calculate latitude and longitude of the target location. The mobile advertising system 130 can verify, or cause to be verified, the advertising content and parameters through a quality assurance (QA) review. The QA review can validate the appropriateness and the legitimacy of the advertising content. If the content passes the QA process, it may be published to “media pool” or “content pool” as ready for publication or web-service access.

The mobile advertising system 130 can support retrieval of advertising media statistics or display information to allow advertisers 110 to review statistics/metrics about advertisement media deployment. The advertiser 110 may select a desired advertisement that they previously uploaded. The mobile advertising system 130 may present a map displaying locations where the advertisement was displayed. Such a map may have push-pins rendered in locations where advertisement media has been displayed. Such push-pins may be selected (or clicked) to show details such as: advertisement display location (e.g. begin and ending latitude/longitude coordinates), advertisement display start and end time, advertisement display duration, and any other related details.

The mobile advertising system 130 may include dedicated or custom advertisement hardware. This hardware may communicate with the advertising server 120 to authenticate itself using a hardware serial number. The mobile system may also provide location information to the server. It should be appreciated that this location information may include data indicating the location, speed, direction, and other parameters associated with the mobile advertising system 130.

The mobile advertising system 130 can continue to execute previously received instructions when communication with the advertising server 120 is unavailable. For example, communication breakdowns may occur due to network outage, coverage limitations (e.g. when passing through a tunnel), or due to weather related issues. The mobile advertising system 130 can locally log any autonomous advertising activities during such periods. The log may then be transmitted to the advertising server 120 as a batch when connectivity is re-established. The advertising server 120 can then determine if those advertisements still qualify for billing against the advertiser 110. Similarly, the mobile advertising system 130 can continue to use a last known location position to continue regular operation for example when there is temporarily no GPS satellite signal.

An advanced scoring algorithm can determine the relevance and order in which advertisements are displayed on each mobile unit. Some of the inputs to the scoring algorithm may include distance, such as the proximity of the advertisement panel to the actual target business location. One of the main objectives of the scoring algorithm includes seeking to maximize advertising revenue by displaying advertisements according to a more relevant or optimized schedule or pattern. Another main objective of the scoring algorithm includes seeking to maximize geographic and temporal coverage.

Other inputs to the scoring may include categories, such as having advertisements classified into different business types such as restaurant, beauty salon, department store, etc. The location of the mobile advertising display panel may also be compared against a region/zone business catalog information database that ranks each zone by business type. A similarity score index may be run against the advertisement category and the region zone catalog. Advertisements with high similarity index may have higher score than those with lower similarity index.

Other inputs to the scoring may include pricing. For example, advertisers may have the option to enter the average dollar amount that a consumer will have to pay to take advantage of the advertisement they are submitting. This price can be classified into continuous or discrete factor levels (ex: low, medium, high, etc.) that may be compared against the publicly available income-per-household census data for each respective location advertisement panels are located.

Other inputs to the scoring may include advertiser purchasing power. For example, high-paying advertisers may be given a competitive advantage/dominance over those that do not spend as much in advertisement dollar amount.

Other inputs to the scoring may include time and date. For example, the scoring engine may give special relevance to advertisements based on their time sensitivity such that an advertisement for “Lunch” will have a higher score before noon that it will have in the afternoon or evening. The time and date used herein may include the time of day, season, day of week, holiday, other time/date information, or any combination thereof.

Other inputs to the scoring may include direction of travel. For example, advertisement mobiles traveling say from airport zone towards downtown may play advertisements in the “hotel” category more frequently while those traveling in the opposite direction will show advertisements for businesses located within the airport such as duty free shops, car rentals, airlines, etc.

Other inputs to the scoring may include advertiser funds remaining For example, advertisers whose advertisement budgets are getting depleted may be given less priority than other advertisements.

Other inputs to the scoring may include traffic characteristics. These may be instantaneous, daily, historic, or any other traffic consideration.

Scoring content and calculating fitness metrics may use the same or similar factors or inputs. These factors may be combined through addition, weighted addition, adaptive weighted addition, multiplication, vector or matrix multiplication, arithmetically, geometrically, exponentially, by multiplication with a scaling or fading factor or function, as inputs to any other numerical or algebraic function, as inputs to time varying or position varying adaptive algorithms, any other operation(s), or any combination thereof.

According to one or more example embodiments, a scoring algorithm may have the form:

score=c[1]*V[1]+c[2]*V[2]+f[3]+f[4]+ . . . c[n]*V[n]+B

or alternatively, a scoring algorithm may have the form:

(c[1]*V[1]+c[2]*V[2]+f[3]+f[4]+ . . . c[n]*V[n]+B)

score=e

where the second example is the first example applied as an exponent of the natural log base “e” and:

c[i]—is coefficient or weight of variable i (numeric)

v—is a predictor variable (numeric)

f—is a factor variable (level)

B—is a base coefficient (offset) for shifting or scaling the output range

Two types of variables used in these algorithms may include numeric and factor variables. A numeric variable may be a value directly multiplied by a corresponding coefficient. An example of a numeric variable may be a distance of a mobile advertising system 130 from a desired central location for display of a particular advertisement. Another example or a numeric variable may be the funds remaining for a particular advertiser 110.

In contrast, a factor variable may be summed or added into the algorithm. An example of a factor variable may be advertiser rank that might be determined based on gross amounts of advertiser payments or some similar global value.

The coefficients (or weights) for the scoring algorithm may be determined through an ongoing process using training, adaptation, statistical model building, validation, and periodic reassessment. The scoring may seek to determine the fitness, frequency, and so forth for advertisement at any given location, time/date that a mobile advertising system 130 may be present.

Scoring optimization may also seek to match advertisement parameters with pre-computed variables through the scoring algorithm. Some example advertising parameters may include: target location for display of advertisement, coverage, radius, days of week to display advertisement, time of day to display, average asking price of goods/services in advertisement, total premium paid, industry classification code for advertiser, total area coverage requested, total amount of premium paid to date, and so forth.

Some example internal (or pre-computed) parameters for a given location or area may include: age demographics, income per household, size of household, housing values, job growth, asking price of goods/services in advertisement, income, social security income, commute duration, home foreclosure rate, own/rent statistics, race demographics, education level demographics, geographical mobility metrics, average rent, average utilities expenses, vehicles per household, indicators of specific industry involvement (medicine, law, technology, education), unemployment rate changes, distance from recreation (beach, mountains, parks), prevalence of local businesses similar to advertising business, and so forth. These parameters may byspecified as means, average, medians, modes, or may be otherwise applied to any other statistical digestion.

Accordingly, some example computed variables may include: the current location of the mobile advertising system 130, current time/date/month/year, distance of mobile advertising system 130 from target location, time difference between current time and desired display time, funds remaining in advertiser's account, direction of travel (e.g. heading to airport, into town, out of town), and so forth.

Predicted future locations for the mobile advertising system 130 may be computed from current location, direction of travel, velocity, map data, and traffic data. Such future information may allow better matching of advertisements as well as queuing of relevant advertising content.

Advertisers may access information on their advertising content in real-time or near-real-time. The advertisers may update the content or parameters regarding the display of the content. The advertisers may also update, allocate, or reallocate advertising budgets or account funds through the advertising server in real-time or near-real-time.

It should be appreciated that the display mechanisms for images, video, audio, and so forth may be used to display local weather, traffic, maps, public service announcements, safety information, game score results, news, and other information. Such display along with the display of advertising content can leverage the dynamic media content handing. Such display may also be location specific and location aware.

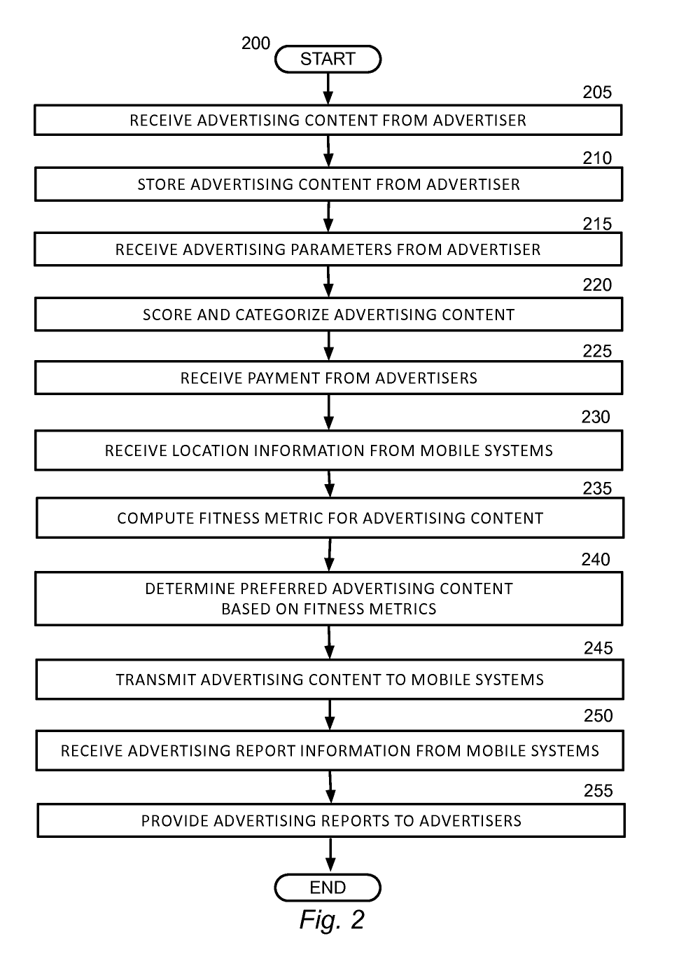

Referring now to FIG. 2, additional details will be provided regarding the embodiments presented herein for location-aware mobile advertising. In particular, FIG. 2 is a flow diagram showing a routine 200 that illustrates aspects of a process for advertising server 120 operations according to one or more embodiments presented herein. It should be appreciated that the logical operations described herein are implemented (1) as a sequence of computer implemented acts, blocks, or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, blocks, or modules. These operations, structural devices, acts, blocks, and modules may be implemented in software, in firmware, in special purpose digital logic, and any combination thereof. It should also be appreciated that more or fewer operations may be performed than shown in the figures and described herein. These operations may also be performed in parallel, or in a different order than those described herein.

In block 205, advertising content may be received from the advertiser 110 into the advertising server 120.

In block 210, the advertising server 120 can store advertising content received from the advertiser 110 in block 205.

In block 215, the advertising server 120 can receive advertising parameters from advertiser 110.

In block 220, the advertising server 120 can score and categorize the advertising content received from the advertiser 110.

In block 225, the advertising server 120 can receive payment from the advertiser 110.

In block 230, the advertising server 120 can receive location information from one or more mobile advertising systems 130. The location information may include position, direction, velocity, path, predicted path, predicted delay characteristics, and any other input from the location to support scoring and allocating advertising opportunities. The advertising server 120 may also receive the local time for each of the mobile advertising systems 130 or the local times may be calculated given the location of the mobile advertising system 130. These local times may be used in computing the fitness metrics for selecting advertising to be presented at a given mobile advertising system 130.

In block 235, the advertising server 120 can compute a fitness metric for advertising content associated with one or more mobile advertising systems 130. It should be appreciated that, according to one or more example embodiments, some or all of the functionality of computing the fitness metric for advertising content may instead be performed at the mobile advertising systems 130. For example, the fitness metrics may be computed in part, or whole, in a distributed fashion by the one or more mobile advertising systems 130, centrally by the advertising server 120, or by some combination thereof.

In block 240, the advertising server 120 can determine preferred advertising content for one or more mobile advertising systems 130. The determination may be based on the computed fitness metrics. It should be appreciated that, according to one or more example embodiments, some or all of the functionality of determining preferred advertising content may instead be performed at the mobile advertising systems 130. For example, the preferred advertising content may be determined in part, or whole, in a distributed fashion by the one or more mobile advertising systems 130, centrally by the advertising server 120, or by some combination thereof.

In block 245, the advertising server 120 may transmit advertising content to one or more mobile advertising systems 130 according to preferred advertising content determined in block 240.

In block 250, the advertising server 120 can receive advertising report information from one or more mobile advertising systems 130.

In block 255, the advertising server 120 can provide advertising reports to advertisers 110 based upon information received in block 250.

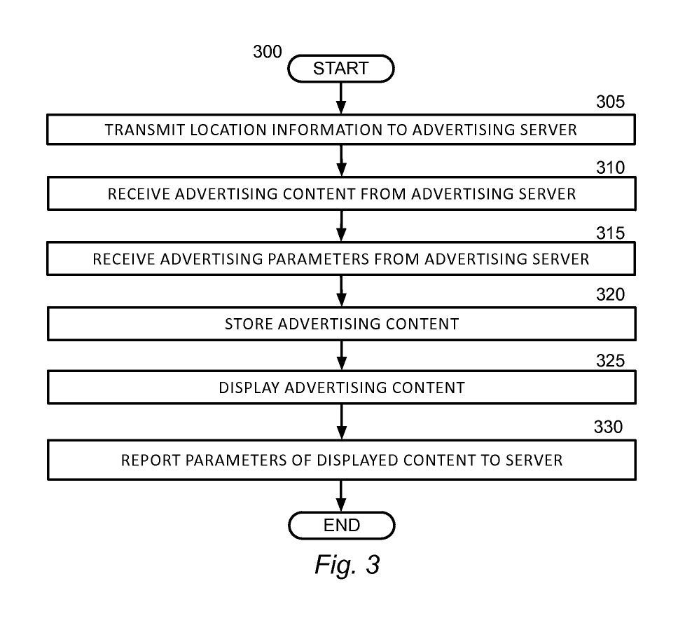

Referring now to FIG. 3, additional details will be provided regarding the embodiments presented herein for location-aware mobile advertising. In particular, FIG. 3 is a flow diagram showing a routine 300 that illustrates aspects of a process for mobile advertisement system operations according to one or more embodiments presented herein. The steps may include:

In block 305, the mobile advertising system 130 may transmit location info to the advertising server 120.

In block 310, the mobile advertising system 130 may receive advertising content from the advertising server 120.

In block 315, the mobile advertising system 130 may receive advertising parameters from the advertising server 120.

In block 320, the mobile advertising system 130 may store advertising content received from the advertising server 120.

In block 325, the mobile advertising system 130 may display advertising content.

In block 330, the mobile advertising system 130 may report parameters of displayed content to the advertising server 120.

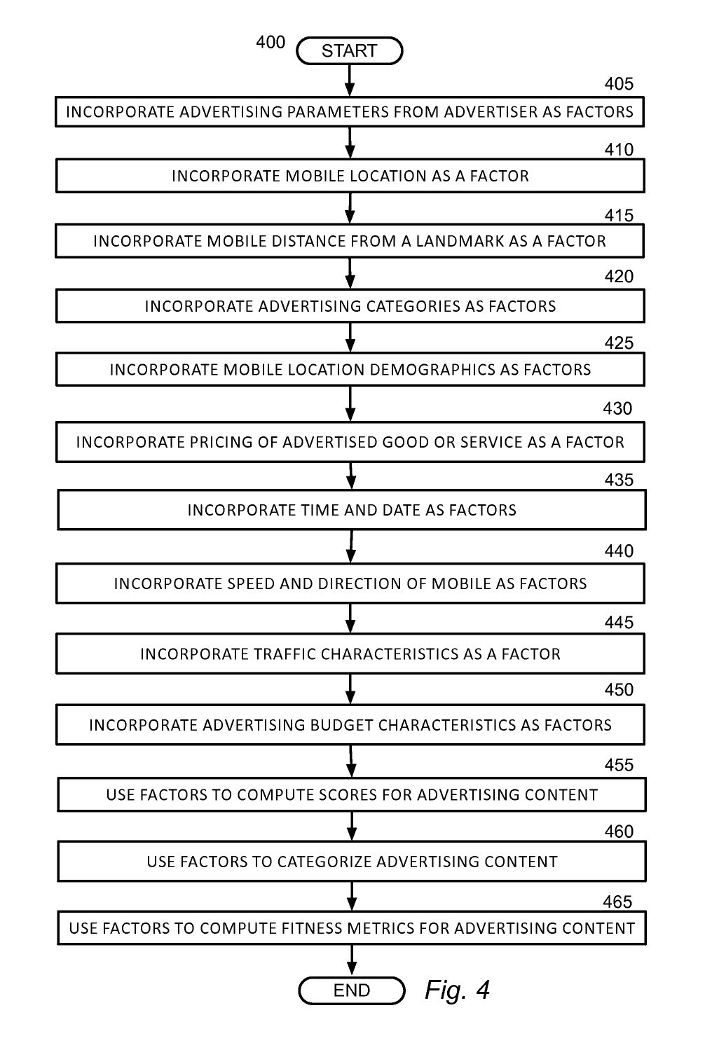

Referring now to FIG. 4, additional details will be provided regarding the embodiments presented herein for location-aware mobile advertising. In particular, FIG. 4 is a flow diagram showing a routine 400 that illustrates aspects of a process for content scoring and fitness metric determination according to one or more embodiments presented herein.

In block 405, advertising parameters from the advertiser 100 may be incorporated as factors for content scoring or fitness metric determination.

In block 410, mobile location may be incorporated as factors for content scoring or fitness metric determination.

In block 415, mobile distance from a landmark may be incorporated as factors for content scoring or fitness metric determination.

In block 420, advertising categories may be incorporated as factors for content scoring or fitness metric determination.

In block 425, mobile location demographics may be incorporated as factors for content scoring or fitness metric determination.

In block 430, pricing of advertised goods or services may be incorporated as factors for content scoring or fitness metric determination.

In block 435, time and date may be incorporated as factors for content scoring or fitness metric determination.

In block 440, speed and direction of the mobile advertising system 130 may be incorporated as factors for content scoring or fitness metric determination.

In block 445, traffic characteristics associated with the mobile advertising system 130 may be incorporated as factors for content scoring or fitness metric determination.

In block 450, advertising budget characteristics may be incorporated as factors for content scoring or fitness metric determination.

In block 455, the various incorporated factors may be used to compute scores for advertising content.

In block 460, the various incorporated factors may be used to categorize advertising content.

In block 465, the various incorporated factors may be used to compute fitness metrics for advertising content.

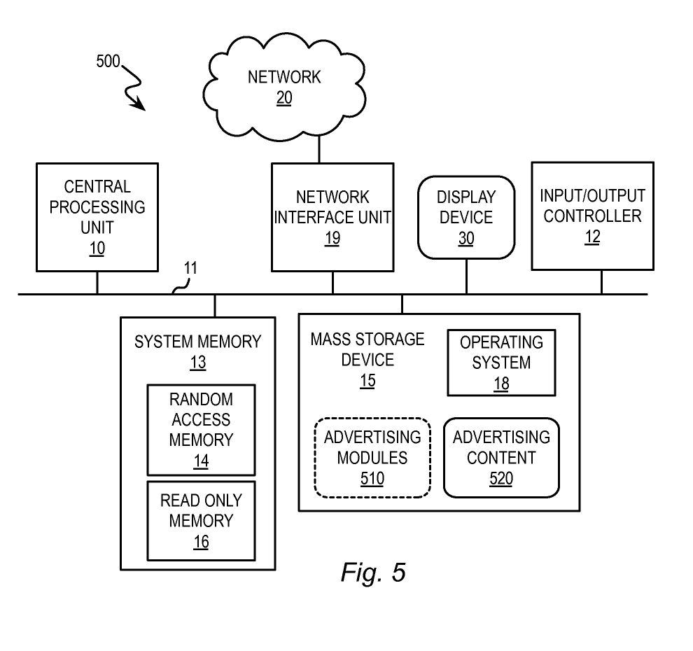

Turning now to FIG. 5, one example is provided of a computer architecture 500 configured to execute software components described herein for location-aware mobile advertising. The computer architecture shown in FIG. 5 illustrates an embedded control computer, a conventional desktop, a laptop, or a server computer and may be utilized to execute aspects of the software components presented herein. It should be appreciated that while a generalized or abstracted computing system is illustrated in FIG. 5, the described software components may be executed on other example computing environments, such as mobile devices, television, set-top boxes, kiosks, vehicular information systems, mobile telephones, embedded systems, or otherwise.

The computer architecture illustrated in FIG. 5 can include a central processing unit 10 (CPU), a system memory 13, including a random access memory 14 (RAM) and a read-only memory 16 (ROM), and a system bus 11 that can couple the system memory 13 to the CPU 10. A basic input/output system containing the basic routines that help to transfer information between elements within the computer 500, such as during startup, can be stored in the ROM 16. The computer 500 may further include a mass storage device 15 for storing an operating system 18, software, data, and various program modules, such the advertising modules 510 and the advertising content 520. The advertising modules 510 may include the advertising server modules 122, the mobile advertising modules 142, or any other related software modules.

The mass storage device 15 can be connected to the CPU 10 through a mass storage controller (not illustrated) connected to the bus 11. The mass storage device 15 and its associated computer-readable media can provide non-volatile storage for the computer 500. Although the description of computer-readable media contained herein refers to a mass storage device, such as a hard disk or CD-ROM drive, it should be appreciated by those skilled in the art that computer-readable media can be any available computer storage media that can be accessed by the computer 500.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the computer 500.

According to various embodiments, the computer 500 may operate in a networked environment using logical connections to remote computers through a network such as the network 20. The computer 500 may connect to the network 20 through a network interface unit 19 connected to the bus 11. It should be appreciated that the network interface unit 19 may also be utilized to connect to other types of networks and remote computer systems.

The computer 500 may also include an input/output controller 12 for receiving and processing input from a number of other devices, including a keyboard, mouse, or electronic stylus (not illustrated). Similarly, an input/output controller 12 may provide output to a video display, a printer, or other type of output device (also not illustrated).

As mentioned briefly above, a number of program modules and data files may be stored in the mass storage device 15 and RAM 14 of the computer 500, including an operating system 18 suitable for controlling the operation of a networked desktop, laptop, server computer, or other computing environment. The mass storage device 15, ROM 16, and RAM 14 may also store one or more program modules. In particular, the mass storage device 15, the ROM 16, and the RAM 14 may store the advertising module 510 for execution by the CPU 10. The advertising module 510 can include software components for implementing portions of the processes discussed in detail with respect to FIGS. 1-4. The mass storage device 15, the ROM 16, and the RAM 14 may also store other types of program modules.

Software modules, such as advertising modules 510 may be associated with the system memory 13, the mass storage device 15, or otherwise. The software modules may include software instructions that, when loaded into the CPU 10 and executed, transform a general-purpose computing system into a special-purpose computing system customized to facilitate all, or part of, the techniques for location-aware mobile advertising as disclosed herein. As detailed throughout this description, the program modules may provide various tools or techniques by which the computer 500 may participate within the overall systems or operating environments using the components, logic flows, and/or data structures discussed herein.

The CPU 10 may be constructed from any number of transistors or other circuit elements, which may individually or collectively assume any number of states. More specifically, the CPU 10 may operate as a state machine or finite-state machine. Such a machine may be transformed to a second machine, or specific machine by loading executable instructions contained within the program modules. These computer-executable instructions may transform the CPU 10 by specifying how the CPU 10 transitions between states, thereby transforming the transistors or other circuit elements constituting the CPU 10 from a first machine to a second machine, wherein the second machine may be specifically configured to support location-aware mobile advertising. The states of either machine may also be transformed by receiving input from one or more user input devices associated with the input/output controller 12, the network interface unit 19, other peripherals, other interfaces, or one or more users or other actors. Either machine may also transform states, or various physical characteristics of various output devices such as printers, speakers, video displays, or otherwise.

Encoding of the program modules may also transform the physical structure of the storage media. The specific transformation of physical structure may depend on various factors, in different implementations of this description. Examples of such factors may include, but are not limited to: the technology used to implement the storage media, whether the storage media are characterized as primary or secondary storage, and the like. For example, if the storage media are implemented as semiconductor-based memory, the program modules may transform the physical state of the system memory 13 when the software is encoded therein. For example, the software may transform the state of transistors, capacitors, or other discrete circuit elements constituting the system memory 13.

As another example, the storage media may be implemented using magnetic or optical technology. In such implementations, the program modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. It should be appreciated that various other transformations of physical media are possible without departing from the scope and spirit of the present description.

Based on the foregoing, it should be appreciated that technologies for location-aware mobile advertising are presented herein. Although the subject matter presented herein has been described in language specific to computer structural features, methodological acts, and computer readable media, it is to be understood that the invention defined is not necessarily limited to the specific features, acts, or media described herein. Rather, the specific features, acts and mediums are disclosed as example forms of implementation.

The subject matter described above is provided by way of illustration only and should not be construed as limiting. Various modifications and changes may be made to the subject matter described herein without following the example embodiments and applications illustrated and described, and without departing from the true spirit and scope of the present invention.

What is claimed is:

1. A computer-implemented method for delivering location-aware advertisements, the method comprising:
receiving advertising content at an advertising server from an advertiser ;
receiving advertising parameters for the advertising content at an advertising server from the advertiser;
receiving location information from a people mover comprising an outdoor display system;
scoring the advertising content;
computing an advertisement fitness metric as a function of the score, the advertising parameters, and the location information; and
transmitting the advertising content to the outdoor display system in response to an indication of the advertisement fitness metric.

2. The method of claim 1, wherein the advertising parameters comprise a target location for the advertising content.

3. The method of claim 1, wherein the people mover comprises a mobile radio interface.

4. The method of claim 1, wherein the people mover comprises a satellite-based positioning system.

5. The method of claim 1, wherein the location information comprises a position, a direction, and a velocity associated with the people mover.

6. The method of claim 1, wherein computing an advertisement fitness metric comprises an adaptive statistical model.

7. The method of claim 1, wherein the people mover comprises one of a car, a bus, or a train.

8. The method of claim 1, further comprising receiving an advertising report from the people mover in response to the advertising content being displayed at the outdoor display system.

9. The method of claim 1, further comprising providing advertising reports to the advertiser.

10. The method of claim 1, further comprising receiving payment from the advertiser.

11. The method of claim 1, wherein the indication of the advertisement fitness metric comprises substantially maximizing advertising revenue.

12. A computer program product, comprising:
a non-transitory computer-readable storage device having computer-readable program instructions embodied thereon, the computer-readable program instructions comprising instructions for:
receiving advertising content at an advertising server from an advertiser ;
receiving advertising parameters for the advertising content at an advertising server from the advertiser;
receiving location information from a mobile advertising platform comprising an outdoor display system;
scoring the advertising content;
computing an advertisement fitness metric as a function of the score, the advertising parameters, and the location information; and
transmitting the advertising content to the outdoor display system in response to an indication of the advertisement fitness metric.

13. The computer program product of claim 12, wherein the mobile advertising platform comprises a satellite-based positioning system.

14. The computer program product of claim 12, wherein the location information comprises position, direction, and velocity of the mobile advertising platform.

15. The computer program product of claim 12, wherein computing an advertisement fitness metric comprises an adaptive statistical model.

16. The computer program product of claim 12, wherein the mobile advertising platform comprises one of a car, a bus, and a train.

17. The computer program product of claim 12, further comprising providing advertising reports to the advertiser.

18. The computer program product of claim 12, further comprising receiving payment from the advertiser.

19. The computer program product of claim 12, wherein the indication of the advertisement fitness metric comprises a joint substantial maximization of time coverage, location coverage, and advertising revenue.

20. A computer-implemented method for delivering location-aware advertisements, the method comprising:
receiving advertising content at an advertising server from an advertiser ;
receiving target location and target air times for the advertising content at an advertising server from the advertiser;
receiving location information from a people mover comprising an outdoor display system;
scoring the advertising content based on target demographics;
computing an advertisement fitness metric as a function of the demographics score, a target location, a target air time, the location information, and a current local time, wherein the advertisement fitness metric seeks to substantially maximize advertising revenue; and
transmitting the advertising content to the outdoor display system in response to an indication of the advertisement fitness metric.
